(19) United States
(12) Patent Application Publication
(10) Pub. No.: US 2025/0272099 A1
(43) Pub. Date: Aug. 28, 2025

(54) METHOD AND DEVICE FOR DATA PROCESSING, AND STORAGE MEDIUM

(71) Applicant: Beijing ESWIN Computing Technology Co., Ltd., Beijing (CN)

(72) Inventor: Chunlei CHANG, Beijing (CN)

(73) Assignee: Beijing ESWIN Computing Technology Co., Ltd., Beijing (CN)

(21) Appl. No.: 18/939,944

(22) Filed: Nov. 7, 2024

(30) Foreign Application Priority Data
Feb. 27, 2024 (CN) 202410218531.1

(51) Int. Cl. G06F 9/30; G06F 12/0875

(52) U.S. Cl. CPC G06F 9/3016; G06F 12/0875; G06F 2212/452

(57) ABSTRACT

A method and device for data processing, and a storage medium are provided. The device includes: a pre-decoding circuit configured to: determine a first sub-block of an instruction block stored in an ICache based on a fetch instruction, determine first pre-decoding information of the first sub-block based on position information of the first sub-block; a pre-decoding check circuit configured to: acquire second pre-decoding information of the first sub-block from the ICache, determine a check result corresponding to the first sub-block based on the first pre-decoding information and the second pre-decoding information, when the check result is a first check result, transmit the first check result to a pre-decoding repair circuit; and the pre-decoding repair circuit configured to: repair second pre-decoding information of at least one target sub-block in the instruction block based on the first pre-decoding information, write the repaired second pre-decoding information back into the ICache.

### CROSS-REFERENCE TO RELATED APPLICATION

This application claims priority to Chinese patent application No. 202410218531.1 filed on Feb. 27, 2024, the disclosure of which is hereby incorporated by reference in its entirety.

### BACKGROUND

In order to balance storage costs and functions of instruction operations, most processing may use variable-length instruction sets. For example, a Reduced Instruction Set Computer V (RISC-V) includes a 32-bit instruction, a 16-bit instruction, etc.

In some implementations, since a position of an instruction in a data block is uncertain (i.e., an instruction boundary is unknown), timing at an instruction prediction stage, an instruction decoding stage or other stages may be tight, which results in a long processor cycle, reduces the operation frequency, and seriously affects the performance of the processor.

### SUMMARY

The disclosure relates to, but is not limited to, the technical field of processors, and in particular to a method, device and apparatus for data processing, an electronic device, and a storage medium.

Embodiments of the disclosure relate to the field of processors, and provide at least a method and device for data processing, and a storage medium.

Technical solutions of the embodiments of the disclosure are implemented as follows.

In a first aspect, an embodiment of the disclosure provides a device for data processing, and the device includes an ICache, a pre-decoding circuit, a pre-decoding check circuit and a pre-decoding repair circuit.

The pre-decoding circuit is configured to: determine a first sub-block from multiple sub-blocks of an instruction block stored in the ICache based on a fetch instruction; and determine first pre-decoding information of the first sub-block based on position information of the first sub-block in the instruction block. The first pre-decoding information of the first sub-block is configured to indicate whether an instruction stored in the first sub-block is an instruction boundary.

The pre-decoding check circuit is configured to: acquire second pre-decoding information of the first sub-block from the ICache; determine a check result corresponding to the first sub-block based on the first pre-decoding information of the first sub-block and the second pre-decoding information of the first sub-block; and when the check result corresponding to the first sub-block is a first check result, transmit the first check result to the pre-decoding repair circuit. The first check result is configured to indicate that the first pre-decoding information of the first sub-block is different from the second pre-decoding information of the first sub-block.

The pre-decoding repair circuit is configured to: repair second pre-decoding information of at least one target sub-block in the instruction block based on the first pre-decoding information of the first sub-block; and write the repaired second pre-decoding information of the at least one target sub-block back into the ICache.

In a second aspect, an embodiment of the disclosure provides a method for data processing, the method includes the following operations.

A first sub-block is determined from multiple sub-blocks of an instruction block stored in an Instruction Cache (ICache) based on a fetch instruction.

First pre-decoding information of the first sub-block is determined based on position information of the first sub-block in the instruction block. The first pre-decoding information of the first sub-block is configured to indicate whether an instruction stored in the first sub-block is an instruction boundary.

Second pre-decoding information of at least one target sub-block in the instruction block is repaired based on the first pre-decoding information of the first sub-block when second pre-decoding information of the first sub-block stored in the ICache is different from the first pre-decoding information of the first sub-block.

In a third aspect, an embodiment of the disclosure provides a computer-readable storage medium having stored thereon a computer program. When being executed by a processor, the computer program is configured to perform the following operations.

A first sub-block is determined from multiple sub-blocks of an instruction block stored in an Instruction Cache (ICache) based on a fetch instruction.

First pre-decoding information of the first sub-block is determined based on position information of the first sub-block in the instruction block. The first pre-decoding information of the first sub-block is configured to indicate whether an instruction stored in the first sub-block is an instruction boundary.

Second pre-decoding information of at least one target sub-block in the instruction block is repaired based on the first pre-decoding information of the first sub-block when second pre-decoding information of the first sub-block stored in the ICache is different from the first pre-decoding information of the first sub-block.

### BRIEF DESCRIPTION OF THE DRAWINGS

Drawings here are incorporated into the description and form a part of the description. These drawings illustrate embodiments in accordance with the disclosure, and are intended to explain technical solutions of the disclosure together with the description.

FIG. 1A is a flowchart of an implementation of a method for data processing provided in an embodiment of the disclosure.

FIG. 1B is a diagram of an instruction block provided in an embodiment of the disclosure.

FIG. 1C is a diagram of an instruction block provided in an embodiment of the

disclosure.

FIG. 2A is a flowchart of an implementation of a method for data processing provided in an embodiment of the disclosure.

FIG. 2B is a diagram of a state machine provided in an embodiment of the disclosure.

FIG. 3A is a flowchart of an implementation of a method for data processing provided in an embodiment of the disclosure.

FIG. 3B is a diagram of an instruction block stored in an ICache provided in an embodiment of the disclosure.

FIG. 4A is a diagram of a compositional structure of a device for data processing provided in an embodiment of the disclosure.

FIG. 4B is a diagram of a compositional structure of a device for data processing provided in an embodiment of the disclosure.

FIG. 4C is a diagram of an instruction block provided in an embodiment of the disclosure.

FIG. 4D is a flowchart of an implementation of a method for data processing provided in an embodiment of the disclosure.

FIG. 5 is a diagram of a compositional structure of an apparatus for data processing provided in an embodiment of the disclosure.

FIG. 6 is a diagram of hardware entities of an electronic device provided in an embodiment of the disclosure.

### DETAILED DESCRIPTION

In order to make the purpose, technical solutions and advantages of the disclosure clearer, the disclosure will be further described in detail below with reference to the drawings. The described embodiments should not be considered as limitation on the disclosure, and all other embodiments obtained by those of ordinary skill in the art without paying any creative work should fall within the scope of protection of the disclosure.

The following description involves the expression “some embodiments”, which describes a subset of all possible embodiments. However, it may be understood that the expression “some embodiments” may be the same or different subsets of all possible embodiments, and may be combined with each other without conflict.

In the following description, the involved terms “first\second\third” are only intended to distinguish similar objects and do not represent a specific order of the objects. It may be understood that the terms “first\second\third” may be interchanged in a specific order or sequence if allowable, so that the embodiments of the disclosure described here can be implemented in an order other than that shown or described here.

Unless otherwise defined, all technical and scientific terms used here have the same meaning as usually understood by those skilled in the art to which the disclosure belongs. The terms used here are only intended to describe the embodiments of the disclosure, and are not intended to limit the disclosure.

In some implementations, since a position of an instruction in a data block is uncertain (i.e., an instruction boundary is unknown), a Central Processing Unit (CPU) may go through a decoding stage in the process of executing the instruction, and the timing at the decoding stage is relatively poor in general, which needs to split the instruction boundary and determine the instruction type and instruction function, or the like. Completing these tasks in a cycle may result in a long logic chain at the decoding stage.

Furthermore, in order to improve instruction parallelism, branch prediction function may be implemented in many CPUs. The branch prediction is composed of dynamic prediction and static prediction. As a supplement to the dynamic prediction, the static prediction may improve accuracy of the branch prediction and reduce loss caused by the failure of the branch prediction. The static prediction requires information such as the instruction boundary, the instruction type, etc. If the decoding of the information is completed at a static prediction stage, the timing pressure at the static prediction stage may be great.

Therefore, the splitting of the instruction boundary may make the timing at an instruction prediction stage, an instruction decoding stage or other stages tight, which results in a long processor cycle, reduces the operation frequency, and seriously affects the performance of the processor. Although performing the pre-decoding (i.e., the splitting of the instruction boundary) in advance may reduce the timing pressures of the decoding stage and the static prediction, it not only requires a high accuracy of pre-decoding (because once the pre-decoding is erroneous, the instruction needs to be re-read from the memory again to determine a correct instruction boundary, which seriously affects the performance and power consumption of the processor), but also requires a compiler to fill an NOP instruction in an invalid part of a cache line, otherwise it may cause the erroneous pre-decoding and increase the dependency of the processor on the compiler.

According to the method for data processing provided by the embodiments of the disclosure, on one hand, on one hand, boundary information of the instruction is stored in the ICache, so that the pre-decoding is performed in advance in refilling of the ICache and timing pressure of splitting the instruction boundary is shared, thereby reducing lengths of logic chains at other stages (such as the instruction prediction stage and the instruction decoding stage) and alleviating the timing pressures at other stages, further enabling the processor to operate at a higher frequency and improving the performance of the processor. On the other hand, when the instruction is fetched from the ICache, error repair is performed on the boundary information stored in the ICache according to the boundary information determined by the position information of the sub-block in the instruction block, which not only allows the error of the pre-decoding and reduces the accuracy requirement of the pre-decoding, but also does not require pre-decoding the instruction again since the erroneous pre-decoding may be automatically repaired, thereby reducing the access consumption to the memory while shortening the instruction-fetching time, and at the same time, allowing a compiler not to perform filling of an NOP instruction in an invalid part of a cache line, and reducing dependency of the processor on the compiler. The method provided in the embodiment of the disclosure may be performed by an electronic device. The electronic device may be various types of terminals such as a laptop computer, a tablet computer, a desktop computer, a set-top box, a mobile device (such as a mobile phone, a portable music player, a Personal Digital Assistant (PDA), a dedicated messaging device, a portable game device) or the like, or may be implemented as a server. The server may be an independent physical server, or may be a server cluster or a distributed system composed of multiple physical servers, or may be a cloud server providing basic cloud computing services, such as cloud services, cloud databases, cloud computing, cloud functions, cloud storage, network services, cloud communications, middleware services, domain name services, security services, Content Delivery Networks (CDNs), big data, Artificial Intelligence (AI) platforms, etc.

Hereinafter, the technical solutions in the embodiments of the disclosure would be clearly and completely described with reference to the drawings in the embodiments of the disclosure.

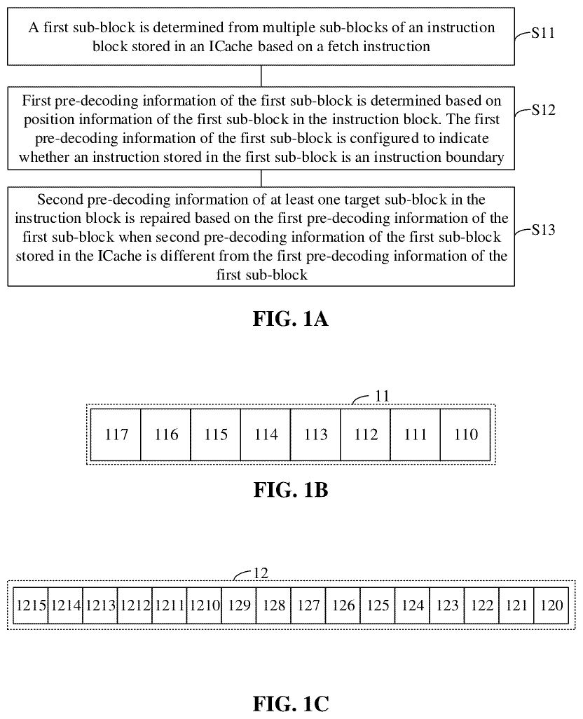

FIG. 1A is a flowchart of an implementation of a method for data processing provided in an embodiment of the disclosure. As shown in FIG. 1A, the method includes the following operations S11 to S13.

In operation S11, a first sub-block is determined from multiple sub-blocks of an instruction block stored in an ICache based on a fetch instruction.

Here, the fetch instruction may be any suitable instruction for fetching an instruction from the ICache. During the process of implementation, when the CPU executes an instruction, it needs to fetch the instruction from a storage unit according to an instruction address stored in a Program Counter (PC). This process is referred to as “instruction-fetching”. The storage unit may be the ICache, a next-level cache, a main memory, etc. The ICache may also be referred to as a Level 1 ICache, belong to a part of a Level 1 Cache, and is configured to store instructions executing data in a Level 1 Data Cache (DCache). A cache is a Level 1 memory existed between the main memory and the CPU is composed of a static memory chip (Static Random Access Memory (SRAM)), which has a small capacity but a speed much higher than that of the main memory and close to that of the CPU.

The instruction block includes multiple sub-blocks, and may store multiple instructions. In the process of implementation, at least one instruction block is stored in the ICache. The sub-block may have a size of a Half Word (HW), and the sub-block may store a complete instruction or a part of an instruction, such as high-order bits of the instruction, low-order bits of the instruction, etc. For example, the HW may include 16 bits, and if an instruction is composed of 32 bits, it needs two sub-blocks to store the instruction, one of which is configured to store the high-order bits of the instruction (that is, high 16 bits), and another one of which is configured to store the low-order bits of the instruction (that is, lower 16 bits).

FIG. 1B is a diagram of an instruction block provided in an embodiment of the disclosure. As shown in FIG. 1B, the instruction block 11 includes 8 sub-blocks (i.e., sub-blocks 110 to 117), and each of the sub-blocks has a size of HW.

The first sub-block is a sub-block in the instruction block. In the implementation, a storage address corresponding to the first sub-block is adapted to an instruction address carried in the fetch instruction.

In operation S12, first pre-decoding information of the first sub-block is determined based on position information of the first sub-block in the instruction block. The first pre-decoding information of the first sub-block is configured to indicate whether an instruction stored in the first sub-block is an instruction boundary.

Here, the position information may be any suitable information, such as offset information from a set sub-block (such as a first one of the sub-blocks, a last one of the sub-blocks, etc.,), a specific position, etc. For example, in FIG. 1B, if the first sub-block is the sub-block 113, the position information of the sub-block 113 in the instruction block may be offset information from the sub-block 110 (that is, 3), or may be the fourth one of the sub-blocks.

Pre-decoding information (including the first pre-decoding information and second pre-decoding information) may be any suitable information, such as an identification bit. For example, a non-instruction boundary is denoted as 0, and the instruction boundary is denoted as 1.

In some implementations, the operation S12 includes the following operation S121 and/or operation S122.

In operation S121, the first pre-decoding information of the first sub-block is determined based on a previous instruction block when the position information is configured to indicate that the first sub-block is a first one of the sub-blocks in the instruction block.

Here, the first pre-decoding information of the first sub-block may be the instruction boundary or the non-instruction boundary. The previous instruction block may refer to a corresponding instruction block read from the ICache in the previous instruction fetching, that is, a certain instruction block in the ICache read correspondingly based on a previous fetch instruction in the previous instruction fetching process., since the same instruction may be located in different instruction blocks, for example, lower-order bits of the instruction are located in a last one of the sub-blocks of the previous instruction block, and high-order bits of the instruction are located in the first one of the sub-blocks of the instruction block. The first pre-decoding information of the first sub-block may be determined according to the previous instruction block.

In some implementations, the operation that the first pre-decoding information of the first sub-block is determined based on the previous instruction block in operation S121 includes the following operations S1211 to S1213.

In operation S1211, instruction information stored in a last one of the sub-blocks of the previous instruction block is acquired.

Here, the instruction information refers to an instruction content stored in the sub-block. In the implementation, it may be obtained by parsing the instruction information that an instruction, high-order bits of an instruction, or low-order bits of an instruction are stored in the last one of the sub-blocks. In some implementations, instruction sets in different architectures may set different values for low-order bits of the instruction. For example, for RISC-V, the values of lower 2 bits of a 32-bit instruction are 11. If the values of lower 2 bits in the instruction information are 11, low-order bits of the instruction are stored in the last one of the sub-blocks. On the contrary, if the values of lower 2 bits in the instruction information are not 11, it indicates that high-order bits of the instruction or an instruction are stored in the last one of the sub-blocks.

FIG. 1C is a diagram of an instruction block provided in an embodiment of the disclosure. As shown in FIG. 1C, the instruction block 12 includes 16 sub-blocks (i.e., sub-blocks 120 to 1215), and each of the sub-blocks has a size of HW.

In operation S1212, second information is taken as the first pre-decoding information of the first sub-block when the instruction information is configured to indicate that low-order bits of the instruction are stored in the last one of the sub-blocks. The second information is configured to indicate that the instruction stored in the first sub-block is a non-instruction boundary.

Here, the second information may be any suitable information, such as a set value (which may be, for example, 0).

When low-order bits of an instruction are stored in the last one the sub-blocks, the first sub-block needs to store the high-order bits of the instruction. That is, the first pre-decoding information of the first sub-block is 0. For example, if the instruction block in FIG. 1C is a previous instruction block of the instruction block in FIG. 1B, when low-order bits of an instruction are stored in the sub-block 1215, the first pre-decoding information of the sub-block 110 is 0.

In operation S1213, first information is taken as the first pre-decoding information of the first sub-block when the instruction information is configured to indicate that high-order bits of the instruction or all bits of the instruction are stored in the last one of the sub-blocks.

Here, the first information may be any suitable information, such as a set value (which may be, for example, 1). In the implementation, the first information is different from the second information.

When an instruction or high-order bits of an instruction are stored in the last one of the sub-blocks, another instruction or low-order bits of another instruction are stored in the first sub-block, that is, the first pre-decoding information of the first sub-block is 1. For example, if the instruction block in FIG. 1C is the previous instruction block of the instruction block in FIG. 1B, when high-order bits of an instruction or an instruction are stored in the sub-block 1215, the first pre-decoding information of the sub-block 110 is 1.

In this way, the first pre-decoding information of the first sub-block is determined in real time according to the instruction information stored in the last one of the sub-blocks of the previous instruction block, thereby improving accuracy of the first pre-decoding information of the first sub-block.

In operation S122, first information is taken as the first pre-decoding information of the first sub-block when the position information is configured to indicate that the first sub-block is not the first one of the sub-blocks in the instruction block. The first information is configured to indicate that the instruction stored in the first sub-block is the instruction boundary.

Here, when the first sub-block is another sub-block, the first pre-decoding information of the first sub-block is the instruction boundary. For example, in FIG. 1B, when the first sub-block is one of sub-blocks 111 to 117, the first pre-decoding information of the first sub-block is the instruction boundary.

In the embodiment of the disclosure, different manners are selected according to different positions of the first sub-block in the instruction block to determine the first pre-decoding information of the first sub-block, thereby improving the comprehensiveness of pre-decoding and the accuracy of the first pre-decoding information.

In operation S13, second pre-decoding information of at least one target sub-block in the instruction block is repaired based on the first pre-decoding information of the first sub-block when second pre-decoding information of the first sub-block stored in the ICache is different from the first pre-decoding information of the first sub-block.

Here, the second pre-decoding information may be an instruction boundary or a non-instruction boundary. In the implementation, when a state of a to-be-fetched instruction in the ICache is a miss state, it needs to continue to fetch instructions from the next-level cache or the main memory until the to-be-fetched instruction is retrieved, and the retrieved to-be-fetched instruction is refilled into the ICache. In the process of refilling, sub-blocks in a retrieved instruction block are pre-decoded according to a preset pre-decoding rule to obtain second pre-decoding information of the sub-blocks, and the sub-blocks and the second pre-decoding information of the sub-blocks are refilled into the ICache. In some implementations, the second pre-decoding information of the sub-block may be located at a left side of the sub-block, a right side of the sub-block, etc.

In some implementations, instruction sets in different architectures may correspond to different pre-decoding rules. For example, for RISC-V, the pre-decoding rule may include, but is not limited to, at least one of:

(1) Pre-decoding information of the first one of the sub-blocks is the instruction boundary;

(2) Low 2 bits of the 32-bit instruction are 11;

(3) Pre-decoding information of a sub-block corresponding to HW at a Start Word (Stwd) is the instruction boundary; or

(4) If pre-decoding information of the previous sub-block is an instruction boundary of the 32-bit instruction, pre-decoding information of a next sub-block is the non-instruction boundary.

In the implementation, the first pre-decoding information of the first sub-block is compared with the second pre-decoding information of the first sub-block to determine whether the pre-decoding is correct. If the first pre-decoding information of the first sub-block is the same as the second pre-decoding information of the first sub-block, it indicates that the pre-decoding is correct. On the contrary, it is indicates that the pre-decoding is erroneous. Then, when the pre-decoding is erroneous, the second pre-decoding information of at least one second sub-block may be repaired according to the first pre-decoding information of the first sub-block.

There may be at least one target sub-block in number. The target sub-block is a sub-block associated with the first sub-block. In some implementations, the second pre-decoding information of the target sub-block is obtained based on the second pre-decoding information of the first sub-block. For example, if storage is performed in an order from small to large, in the instruction block, the storage address of the first sub-block should be smaller than that of the target sub-block. On the contrary, if storage is performed in an order from large to small, in the instruction block, the storage address of the first sub-block should be larger than that of the target sub-block.

In some implementations, the at least one target sub-block may include only the first sub-block. For example, in the instruction block shown in FIG. 1B, if the first sub-block is the sub-block 117, the at least one target sub-block only includes the sub-block 117 since the sub-block 117 is the last one of the sub-blocks in the instruction block.

In some implementations, the at least one target sub-block may also include the first sub-block and at least one second sub-block. For example, in the instruction block shown in FIG. 1B, storage addresses of the sub-blocks 110 to 117 are increased sequentially, and storage of the instruction block is performed in an order from small to large. If the first sub-block is the sub-block 115, since the sub-block 115 is not the last one of the sub-blocks in the instruction block, the address of the sub-block 116 is larger than that of the sub-block 115, and the second pre-decoding information of the sub-block 116 is obtained based on the second pre-decoding information of the sub-block 115; the address of the sub-block 117 is larger than that of the sub-block 116, and the second pre-decoding information of the sub-block 117 is obtained based on the second pre-decoding information of the sub-block 116. Therefore, the at least one target sub-block includes the first sub-block (that is, the sub-block 115) and two second sub-blocks (that is, the sub-block 116 and the sub-block 117). In the implementation, if there is one target sub-block, only the second pre-decoding information of the first sub-block is repaired. If there are at least two target sub-blocks, the second pre-decoding information of the first sub-block and at least one second sub-block needs to be repaired.

In the process of repairing the pre-decoding, if the second pre-decoding information of the sub-block is correct, the second pre-decoding information of the sub-block is kept unchanged. On the contrary, if the second pre-decoding information of the sub-block is erroneous, the second pre-decoding information of the sub-block needs to be updated to correct pre-decoding information.

In some implementations, if the at least one target sub-block includes at least one second sub-block, for each second sub-block, the first pre-decoding information (that is, the correct pre-decoding information) of the second sub-block may be determined according to instruction information stored in the previous sub-block, and then the second pre-decoding information of the second sub-block may be repaired according to the first pre-decoding information of the second sub-block.

In the embodiment of the disclosure, on one hand, on one hand, boundary information of the instruction is stored in the ICache, so that the pre-decoding is performed in advance in refilling of the ICache and timing pressure of splitting the instruction boundary is shared, thereby reducing lengths of logic chains at other stages (such as the instruction prediction stage and the instruction decoding stage) and alleviating the timing pressures at other stages, further enabling the processor to operate at a higher frequency and improving the performance of the processor. On the other hand, when the instruction is fetched from the ICache, error repair is performed on the boundary information stored in the ICache according to the boundary information determined by the position information of the sub-block in the instruction block, which not only allows the error of the pre-decoding and reduces the accuracy requirement of the pre-decoding, but also does not require pre-decoding the instruction again since the erroneous pre-decoding may be automatically repaired, thereby reducing the access consumption to the memory while shortening the instruction-fetching time, and at the same time, allowing a compiler not to perform filling of an NOP instruction in an invalid part of a cache line, and reducing dependency of the processor on the compiler.

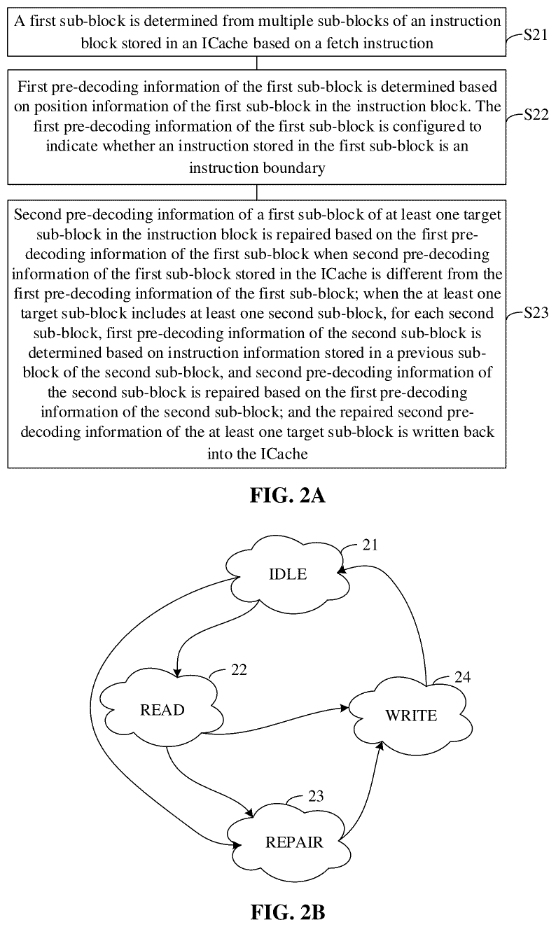

FIG. 2A is a flowchart of an implementation of a method for data processing provided in an embodiment of the disclosure. As shown in FIG. 2A, the method includes the following operations S21 to S23.

In operation S21, a first sub-block is determined from multiple sub-blocks of an instruction block stored in an ICache based on a fetch instruction.

In operation S22, first pre-decoding information of the first sub-block is determined based on position information of the first sub-block in the instruction block. The first pre-decoding information of the first sub-block is configured to indicate whether an instruction stored in the first sub-block is an instruction boundary.

Here, the above operations S21 and S22 correspond to the foregoing operations S11 and S12, respectively, and in implementation, may refer to specific implementation processes of the foregoing operations S11 and S12.

In operation S23, second pre-decoding information of a first sub-block of at least one target sub-block in the instruction block is repaired based on the first pre-decoding information of the first sub-block when second pre-decoding information of the first sub-block stored in the ICache is different from the first pre-decoding information of the first sub-block; when the at least one target sub-block includes at least one second sub-block, for each second sub-block, first pre-decoding information of the second sub-block is determined based on instruction information stored in a previous sub-block of the second sub-block, and second pre-decoding information of the second sub-block is repaired based on the first pre-decoding information of the second sub-block; and the repaired second pre-decoding information of the at least one target sub-block is written back into the ICache.

Here, there may be at least one target sub-block. The at least one target sub-block may include only the first sub-block, or may include the first sub-block and at least one second sub-block.

Since the second pre-decoding information of the first sub-block is erroneous, the pre-decoding of the first sub-block needs to be repaired. In the implementation, repair of the the pre-decoding information of the first sub-block is achieved by updating the second pre-decoding information of the first sub-block to be the first pre-decoding information of the first sub-block.

In some implementations, the pre-decoding of the instruction block may be repaired by a preset state machine. The state machine may be any suitable state machine. States of the state machine may include, but are not limited to, an initial state (IDLE), a read state (READ), a repair state (REPAIR), a writing state (WRITE), etc. IDLE is the default state. READ refers to re-reading the ICache to acquire the second pre-decoding information of the target sub-blocks. REPAIR refers to updating the second pre-decoding information of the target sub-blocks to be the first pre-decoding information of the sub-block. WRITE refers to writing the repaired second pre-decoding information of the target sub-blocks back into the ICache.

FIG. 2B is a diagram of a state machine provided in an embodiment of the disclosure. As shown in FIG. 2B, the state machine 20 includes an initial state 21, a read state 22, a repair state 23, and a writing state 24. The initial state 21 may enter the read state 22 or the repair state 23, the read state 22 may enter the repair state 23 or the writing state 24, the repair state 23 may enter the writing state 24, and the writing state 24 returns to the initial state 21, so as to complete the repair of the pre-decoding information of the instruction block.

In some implementations, when the at least one target sub-block only includes the first sub-block, the second pre-decoding information of the first sub-block is written back into the ICache after the update of the second pre-decoding information of the first sub-block is completed, so that the pre-decoding of the instruction block is repaired. For example, in the state machine shown in FIG. 2B, the pre-decoding of the instruction block is repaired, which may include the following operations: the initial state 21 enters the repair state 23, the repair state 23 enters the writing state 24, and the writing state 24 returns to the initial state 21.

In some implementations, the at least one target sub-block includes the first sub-block, and the operation that the second pre-decoding information of the first sub-block is repaired based on the first pre-decoding information of the first sub-block in the operation S23 includes the following operation S231.

In operation S231, the second pre-decoding information of the first sub-block is updated to the first pre-decoding information of the first sub-block.

Here, since the second pre-decoding information of the first sub-block is erroneous, the second pre-decoding information of the first sub-block needs to be replaced with the first pre-decoding information of the first sub-block.

In this way, an accurate instruction boundary is obtained by timely repairing the second pre-decoding information of the first sub-block in the ICache to provide modification basis for repairing the pre-decoding of other sub-blocks, thereby shortening the timing pressures at the subsequent stages and improving the performance of the processor.

When the at least one target sub-block includes at least one second sub-block, the pre-decoding of the at least one second sub-block needs to be repaired. In the implementation, if the second pre-decoding information of the second sub-block is correct, the second pre-decoding information of the second sub-block is kept unchanged. On the contrary, if the second pre-decoding information of the second sub-block is erroneous, the second pre-decoding information of the second sub-block needs to be updated to the first pre-decoding information of the second sub-block.

In some implementations, the operation that the first pre-decoding information of the second sub-block is determined based on the instruction information stored in the previous sub-block of the second sub-block in the operation S23 includes the following operations S241 and S242.

In operation S241, second information is taken as the first pre-decoding information of the second sub-block when the instruction information is configured to indicate that low-order bits of the instruction are stored in the previous sub-block.

Here, the previous sub-block is adjacent to the second sub-block. For example, in FIG. 1B, if the second sub-block is the sub-block 114, the previous sub-block is the sub-block 113.

The instruction information refers to an instruction content stored in the sub-block. In the implementation, it may be obtained by parsing the instruction information that an instruction, high-order bits of an instruction, or low-order bits of an instruction are stored in the previous sub-block. When low-order bits of an instruction are stored in the previous sub-block, the second sub-block needs to store high-order bits of the instruction. Therefore the first pre-decoding information of the second sub-block is the second information.

In operation S242, first information is taken as the first pre-decoding information of the second sub-block when the instruction information is configured to indicate that high-order bits of the instruction or all bits of the instruction are stored in the previous sub-block.

Here, when an instruction or high-order bits of an instruction are stored in the previous sub-block, the second sub-block may store another instruction or low-order bits of another instruction. Therefore the first pre-decoding information of the second sub-block is the first information.

In this way, the first pre-decoding information of the second sub-block is determined in real time according to the instruction information stored in the previous sub-block, thereby improving the accuracy of the first pre-decoding information of the second sub-block.

In some implementations, the operation that the second pre-decoding information of the second sub-block is repaired based on the first pre-decoding information of the second sub-block in the operation S23 includes the following operations S251 to S253.

In operation S251, the second pre-decoding information of the second sub-block is read from the ICache.

Here, the second pre-decoding information of the second sub-block may be erroneous or correct. Therefore, it needs to read the second pre-decoding information of the second sub-block from the ICache. In some implementations, when there are at least two second sub-blocks, the ICache may be read only once to obtain the respective second pre-decoding information of each of the second sub-blocks. In this way, resource consumption due to multiple readings may be reduced.

In operation S252, the second pre-decoding information of the second sub-block is updated to the first pre-decoding information of the second sub-block when the second pre-decoding information of the second sub-block is different from the first pre-decoding information of the second sub-block.

Here, the second pre-decoding information of the second sub-block is different from the first pre-decoding information of the second sub-block, which indicates that the second pre-decoding information of the second sub-block is erroneous. Therefore, the second pre-decoding information of the second sub-block needs to be repaired. In the implementation, the second pre-decoding information of the second sub-block may be replaced with the first pre-decoding information of the second sub-block to complete the repair of the pre-decoding information of the second sub-block.

In some implementations, the repair of the pre-decoding of the instruction block may be completed by the state machine. For example, if the second pre-decoding information of at least one second sub-block is different from the corresponding first pre-decoding information, in the state machine shown in FIG. 2B, the repair of the pre-decoding of the instruction block may include the following operations: the initial state 21 enters the read state 22, the read state 22 enters the repair state 23, the repair state 23 enters the writing state 24, and the writing state 24 returns to the initial state 21. In the implementation, after the repair of the pre-decoding information of the target sub-blocks in the instruction block is completed, the repaired second pre-decoding information of the target sub-blocks is written back into the ICache (that is, enters the writing state) to complete the repair of the pre-decoding of the instruction block.

In operation S253, the second pre-decoding information of the second sub-block is kept unchanged when the second pre-decoding information of the second sub-block is the same as the first pre-decoding information of the second sub-block.

Here, the second pre-decoding information of the second sub-block is the same as the first pre-decoding information of the second sub-block, which indicates that the second pre-decoding information of the second sub-block is correct, and the second pre-decoding information of the second sub-block is kept unchanged to complete the repair of the pre-decoding information of the second sub-block.

In this way, an accurate instruction boundary is obtained by timely repairing the second pre-decoding information of the second sub-block in the ICache, thereby shortening the timing pressures at subsequent stages and improving performance of the processor.

After the repair of the second pre-decoding information of the target sub-blocks is completed, the repaired second pre-decoding information of the target sub-blocks is simultaneously written back into the ICache to reduce the resource consumption due to frequent writing.

In the embodiment of the disclosure, the second pre-decoding information of the first sub-block of at least one target sub-block in the instruction block is repaired based on the first pre-decoding information of the first sub-block when the second pre-decoding information of the first sub-block stored in the ICache is different from the first pre-decoding information of the first sub-block; when the at least one target sub-block includes at least one second sub-block, for each second sub-block, the first pre-decoding information of the second sub-block is determined based on the instruction information stored in the previous sub-block of the second sub-block, and the second pre-decoding information of the second sub-block is repaired based on the first pre-decoding information of the second sub-block; the repaired second pre-decoding information of the at least one target sub-block is written back into the ICache. In this way, an accurate instruction boundary is obtained by timely repairing the second pre-decoding information of the sub-block in the ICache. On one hand, the timing pressures at the subsequent stages are shortened and the performance of the processor is improved. On the other hand, since the error of the pre-decoding is allowed, the requirements of the accuracy of the pre-decoding are reduced. Furthermore, since the erroneous pre-decoding can be repaired automatically, there is no need to pre-decode the instruction again, so that the consumption of the access to the memory can be reduced while shortening instruction-fetching time, and a compiler may be allowed not to perform the filling of an NOP instruction in an invalid part of a cache line, thereby reducing the dependency of the processor on the compiler.

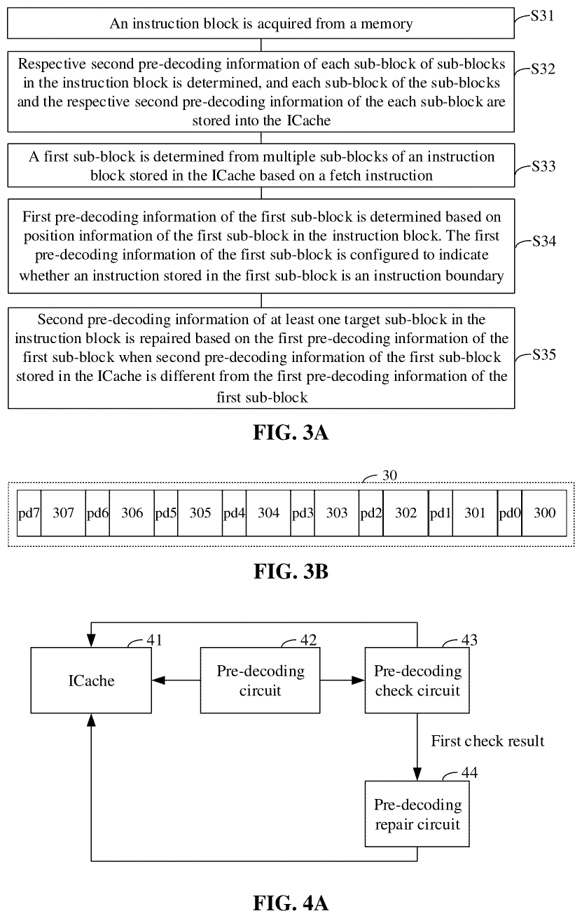

FIG. 3A is a flowchart of an implementation of a method for data processing provided in an embodiment of the disclosure. As shown in FIG. 3A, the method includes the following operations S31 to S35.

In operation S31, an instruction block is acquired from a memory.

Here, the memory refers to the next-level cache or another memory of the ICache. In the implementation, when the CPU executes an instruction A, it needs to fetch instructions from the ICache at first. When a state in the ICache is a miss state, it needs to continue to fetch instructions from the next-level cache or the main memory until the instruction A is retrieved, and the retrieved instruction is refilled into the ICache. In some implementations, continuing to fetch instructions may refer to fetching a set of instructions (that is, the instruction block), and the set of instructions includes the instruction A.

In operation S32, respective second pre-decoding information of each sub-block of sub-blocks in the instruction block is determined, and each sub-block of the sub-blocks and the respective second pre-decoding information of the sub-block are stored into the ICache.

Here, the second pre-decoding information may be an instruction boundary or a non-instruction boundary. In some implementations, the sub-blocks in the retrieved instruction block are pre-decoded according to a preset pre-decoding rule to obtain the respective second pre-decoding information of each sub-block. In some implementations, instruction sets in different architectures may correspond to different pre-decoding rules.

In some implementations, the operation that the respective second pre-decoding information of each of the sub-blocks in the instruction block is determined in the operation S32 includes the following operations S321 and S322.

In operation S321, first information is taken as second pre-decoding information of a first one of the sub-blocks.

Here, the first one of the sub-blocks in the instruction block is the instruction boundary by default, that is, the second pre-decoding information of the first one of the sub-blocks is the first information. For example, in the instruction block shown in FIG. 1B, the second pre-decoding information of the sub-block 110 is the first information.

In operation S322, for each of third sub-blocks in the instruction block, second pre-decoding information of the third sub-block is determined based on instruction information stored in a previous sub-block of the third sub-block, and each of the third sub-blocks is not the first one of the sub-blocks.

Here, there may be at least one third sub-block. The third sub-block may be other sub-blocks in the instruction block except the first one of the sub-blocks. For example, in the instruction block shown in FIG. 1B, the at least one third sub-block includes 7 sub-blocks (i.e., sub-blocks 111 to 117).

The previous sub-block is adjacent to the third sub-block. For example, in FIG. 1B, if the third sub-block is the sub-block 113, the previous sub-block is the sub-block 112.

The instruction information refers to an instruction content stored in the sub-block. It may be obtained by parsing the instruction information that an instruction, high-order bits of an instruction, or low-order bits of an instruction are stored in the previous sub-block. In the implementation, the second pre-decoding information of the third sub-block may be obtained according to the instruction information.

In some implementations, the operation that the second pre-decoding information of the third sub-block is determined based on the instruction information stored in the previous sub-block of the third sub-block in the operation S322 includes the operation S3221 and/or operation S3222.

In operation S3221, second information is taken as first pre-decoding information of the third sub-block when the instruction information is configured to indicate that low-order bits of the instruction are stored in the previous sub-block.

Here, if low-order bits of an instruction are stored in the previous sub-block, the third sub-block needs to store high-order bits of the instruction. Therefore the first pre-decoding information of the third sub-block is the second information.

In operation S3222, first information is taken as the first pre-decoding information of the third sub-block when the instruction information is configured to indicate that high-order bits of the instruction or all bits of the instruction are stored in the previous sub-block.

Here, when high-order bits of an instruction or an instruction are stored in the previous sub-block, the third sub-block may store another instruction or low-order bits of another instruction. Therefore the first pre-decoding information of the third sub-block is the first information.

In this way, the second pre-decoding information of the third sub-block is determined in real time according to the instruction information stored in the previous sub-block, thereby improving the accuracy of the second pre-decoding information of the second sub-block.

After the second pre-decoding information of the sub-blocks is determined, the sub-blocks and the second pre-decoding information of the sub-blocks are refilled into the ICache. The second pre-decoding information of the sub-block may be located at a left side of the sub-block, a right side of the sub-block, etc.

FIG. 3B is a diagram of an instruction block stored in an ICache provided in an embodiment of the disclosure. As shown in FIG. 3B, the instruction block 30 includes 8 sub-blocks (i.e., sub-blocks 300 to 307), and the respective second pre-decoding information of each of the sub-blocks is located at a left side of the corresponding sub-block (i.e., pd0 to pd7).

In some implementations, each of the sub-blocks in the retrieved instruction block may be separately pre-decoded simultaneously according to two different pre-decoding rules to obtain two respective types of second pre-decoding information of each of the sub-blocks. For example, the first pre-decoding rule lies in that the second pre-decoding information of the first one of the sub-blocks is a non-instruction boundary, and second pre-decoding information of other sub-blocks is obtained according to the second pre-decoding information of the first one of the sub-blocks. The second decoding rule lies in that the second pre-decoding information of the first one of the sub-blocks is an instruction boundary, and the second pre-decoding information of other sub-blocks is obtained according to the second pre-decoding information of the first one of the sub-blocks. Finally, each sub-block and two respective types of second pre-decoding information of each sub-block are refilled into the ICache. In some implementations, the respective second pre-decoding information of each sub-block may be denoted by 2 bits. The first bit denotes a first type of the second pre-decoding information, and the second bit denotes a second type of the second pre-decoding information. In this way, the number of repairs is reduced by determining different second pre-decoding information of each sub-block in advance. Since it is unnecessary to determine the first pre-decoding information of the sub-blocks again in the subsequent repair processes, the repair time is shortened, and the repair efficiency is improved.

In operation S33, a first sub-block is determined from multiple sub-blocks of an instruction block stored in the ICache based on a fetch instruction.

In operation S34, first pre-decoding information of the first sub-block is determined based on position information of the first sub-block in the instruction block. The first pre-decoding information of the first sub-block is configured to indicate whether an instruction stored in the first sub-block is an instruction boundary.

In operation S35, second pre-decoding information of at least one target sub-block in the instruction block is repaired based on the first pre-decoding information of the first sub-block when second pre-decoding information of the first sub-block stored in the ICache is different from the first pre-decoding information of the first sub-block.

Here, the above operations S33 to S35 correspond to the foregoing operations S11 to S13 respectively, and in implementation, may refer to specific implementation processes of the foregoing operations S11 to S13.

In the embodiment of the disclosure, the pre-decoding information of the sub-blocks is determined in real time, and the sub-blocks and the pre-decoding information of the sub-blocks are refilled into the ICache, so that the pre-decoding can be performed in advance in the refilling of the ICache, which shares the timing pressure of splitting the instruction boundary, thereby alleviating the timing pressures at other stages, further enabling the processor to better support efficient execution of an instruction pipeline and improving the performance of the processor.

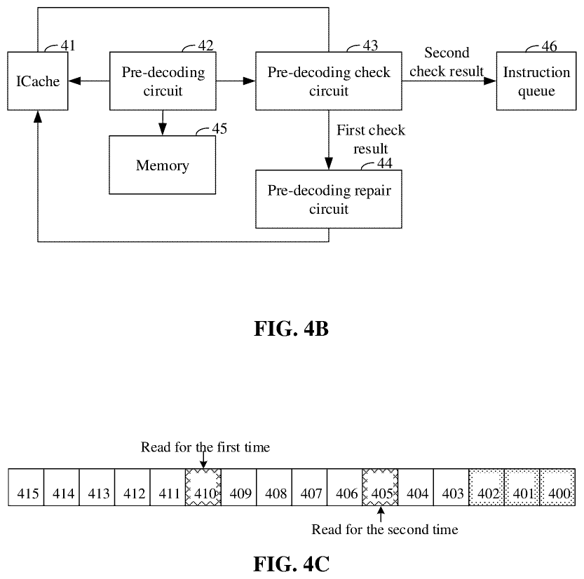

Based on the above embodiments, an embodiment of the disclosure provides a device for data processing. FIG. 4A is a diagram of a compositional structure of a device for data processing provided in an embodiment of the disclosure. As shown in FIG. 4A, the device for data processing includes an ICache 41, a pre-decoding circuit 42, a pre-decoding check circuit 43 and a pre-decoding repair circuit 44.

The pre-decoding circuit 42 is configured to: determine a first sub-block from multiple sub-blocks of an instruction block stored in the ICache 41 based on a fetch instruction; and determine first pre-decoding information of the first sub-block based on position information of the first sub-block in the instruction block. The first pre-decoding information of the first sub-block is configured to indicate whether an instruction stored in the first sub-block is an instruction boundary.

The pre-decoding check circuit 43 is configured to: acquire second pre-decoding information of the first sub-block from the ICache; determine a check result corresponding to the first sub-block based on the first pre-decoding information of the first sub-block and the second pre-decoding information of the first sub-block; and when the check result corresponding to the first sub-block is a first check result, transmit the first check result to the pre-decoding repair circuit. The first check result is configured to indicate that the first pre-decoding information of the first sub-block is different from the second pre-decoding information of the first sub-block.

The pre-decoding repair circuit 44 is configured to: repair second pre-decoding information of at least one target sub-block in the instruction block based on the first pre-decoding information of the first sub-block; and write the repaired second pre-decoding information of the at least one target sub-block back into the ICache.

Here, the pre-decoding circuit 42 may be any suitable circuit capable of implementing the function, such as a digital circuit, an analog circuit, etc. The pre-decoding circuit 42 determines a sub-block according to an instruction-fetching sub-block, and performs a pre-decoding operation on the sub-block to generate first pre-decoding information of the sub-block. In the implementation, the process of determining the first sub-block by the pre-decoding circuit may refer to the specific implementation of the foregoing operation S11. The process of determining the first pre-decoding information of the first sub-block by the pre-decoding circuit may refer to the specific implementation of the foregoing operation S11.

In some implementations, the pre-decoding circuit is further configured to: acquire the instruction block from a memory; and determine respective second pre-decoding information of each sub-block of the sub-blocks, and store each sub-block of the sub-blocks and the respective second pre-decoding information of the sub-block into the ICache.

Here, the memory refers to the next-level cache or another memory of the ICache. In the implementation, the pre-decoding circuit fetches instructions from the ICache according to the fetch instruction at first. When a state in the ICache is a miss state, it needs to continue to fetch instructions from the next-level cache or the main memory until the instruction is retrieved, and the retrieved instruction is refilled into the ICache. The process of determining the second pre-decoding information of the sub-blocks by the pre-decoding circuit may refer to the specific implementation of the foregoing operation S32.

The pre-decoding check circuit 43 may be any suitable circuit capable of implementing the function, such as an analog circuit, a digital circuit, etc. The pre-decoding check circuit checks the first pre-decoding information and the second pre-decoding information of the sub-block to obtain a check result corresponding to the sub-block.

The check result may include, but is not limited to, a first check result, a second check result, etc. The first check result is configured to indicate that the first pre-decoding information of the sub-block is different from the second pre-decoding information of the sub-block, and the second check result is configured to indicate that the first pre-decoding information of the sub-block is the same as the second pre-decoding information of the sub-block. In some implementations, the pre-decoding check circuit may acquire the first pre-decoding information of the sub-block from the pre-decoding circuit, or the pre-decoding circuit may transmit the first pre-decoding information of the sub-block to the pre-decoding check circuit. In the implementation, manners of the transmission may include, but are not limited to, direct transmission, broadcast, etc. In some implementations, the pre-decoding check circuit is connected to the pre-decoding circuit.

In the implementation, if the check result corresponding to the sub-block is the first check result, the target sub-block in the instruction block needs to be repaired, and the first check result corresponding to the sub-block is transmitted to the pre-decoding repair circuit. If the check result corresponding to the sub-block is the second check result, it is not necessary to repair the instruction block, and the check result corresponding to the sub-block is not transmitted to the pre-decoding repair circuit.

In some implementations, the pre-decoding check circuit is further configured to store the instruction stored in the first sub-block into a preset instruction queue when the check result corresponding to the first sub-block is a second check result.

Here, the instruction queue is configured to store an instruction corresponding to the fetch instruction. In the implementation, if the check result corresponding to the sub-block is the second check result, it is indicated that the second pre-decoding information of the sub-block is correct, and it is unnecessary to repair the instruction block to which the sub-block belongs, then the instruction stored in the sub-block is normally fetched, and the instruction is stored in the instruction queue.

The pre-decoding repair circuit 44 may be any suitable circuit capable of implementing the function, such as an analog circuit, a digital circuit, etc. The pre-decoding repair circuit repairs the second pre-decoding information of at least one target sub-block in the instruction block to which the sub-block belongs, and writes the repaired second pre-decoding information of the target sub-block backs into the ICache. In the implementation, the process of performing repair by the pre-decoding repair circuit may refer to the specific implementation of the foregoing operation S13 or operation S23

In some implementations, the pre-decoding repair circuit may acquire the first pre-decoding information of the first sub-block from the pre-decoding check circuit, or the pre-decoding check circuit may transmit the first pre-decoding information of the first sub-block to the pre-decoding repair circuit. In the implementation, manners of the transmission may include, but are not limited to, direct transmission, broadcast, etc. In some implementations, the pre-decoding check circuit is connected to the pre-decoding repair circuit.

FIG. 4B is a diagram of a compositional structure of a device for data processing provided in an embodiment of the disclosure. As shown in FIG. 4B, the device for data processing includes an ICache 41, a pre-decoding circuit 42, a pre-decoding check circuit 43, a pre-decoding repair circuit 44, a memory 45 and an instruction queue 46.

Descriptions are made below by taking a processor based on a RISC-V architecture as an example.

In some implementations, an instruction set of RISC-V usually includes a 32-bit instruction and a 16-bit instruction. In the process of executing an instruction by the CPU, the CPU may go through a prediction stage, a decoding stage, or the like. It needs to acquire the instruction boundary and the instruction type at the prediction stage, and it needs to acquire the instruction boundary, the instruction type and the instruction function at the decoding stage. Completing these tasks in a cycle may result in a long logic chain at these stages. Although performing the pre-decoding in advance may reduce the timing pressures of the decoding stage and static prediction, it requires a high accuracy of the pre-decoding, which is because once the pre-decoding is erroneous, the instruction needs to be re-read from the memory again to determine a correct instruction boundary, thereby seriously affecting the performance and power consumption of the CPU. Furthermore, it requires a compiler to fill a NOP instruction in an invalid part of a cache line, otherwise it may cause the erroneous pre-decoding and increase the dependency of the CPU on the compiler.

In the CPU encoding, codes which are not completely statically encoded are usually used. Then, in the process of execution of the program, the codes may be updated and changed accordingly, so that a valid instruction is located in the middle of the cache line, and there may be invalid data in the cache line at this time. Since the pre-decoding is derived backward from a first one of the sub-blocks of an instruction block, if the second pre-decoding information of the first one of the sub-blocks is erroneous, the second pre-decoding information of all other sub-blocks may be erroneous.

FIG. 4C is a diagram of an instruction block provided in an embodiment of the disclosure. As shown in FIG. 4C, the instruction block includes 16 sub-blocks (i.e., sub-blocks 400 to 415), and invalid data are stored in the sub-blocks 400 to 402.

When the instruction block 40 is read for the first time, the determined first sub-block is the sub-block 410. If the second pre-decoding information of the sub-block 410 is an instruction boundary, it is indicated that the second pre-decoding information of the sub-block 410 is correct. Since the second pre-decoding information of sub-blocks 411 to 415 are determined based on the second pre-decoding information of the sub-block 410, the second pre-decoding information of the sub-blocks 411 to 415 are also correct, however, the second pre-decoding information of the sub-blocks 400 to 409 may be erroneous.

When the instruction block 40 is read for the second time, the determined first sub-block is the sub-block 405. If the second pre-decoding information of the sub-block 405 is a non-instruction boundary, it is indicated that the second pre-decoding information of the sub-block 405 is erroneous. Since the second pre-decoding information of the sub-blocks 406 to 409 are determined based on the second pre-decoding information of the sub-block 405, the second pre-decoding information of the sub-blocks 406 to 409 may be erroneous.

In the implementation, the instruction stored in the sub-block may be a 16-bit instruction, low 16 bits of a 32-bit instruction, high 16 bits of the 32-bit instruction, etc. After the sub-block is pre-decoded, the second pre-decoding information of the sub-block may be an instruction boundary, a non-instruction boundary, etc. Possibilities of errors in the second pre-decoding information of the sub-block are mainly divided into the following types.

(1) The instruction stored in the sub-block is a non-instruction boundary, while the second pre-decoding information of the sub-block is an instruction boundary of the 16-bit instruction or an instruction boundary of the 32-bit instruction.

For example, in FIG. 1B, the instruction stored in the sub-block 110 is the non-instruction boundary, while the second pre-decoding information of the sub-block 110 is the instruction boundary of the 32-bit instruction.

(2) The instruction stored in the sub-block is an instruction boundary of the 16-bit instruction, while the second pre-decoding information of the sub-block is a non-instruction boundary.

For example, in FIG. 4C, when the instruction is fetched for the second time, the instruction stored in the sub-block 405 is the instruction boundary and low 2 bits of the sub-block 405 are not 11, while the second pre-decoding information of the sub-block is the non-instruction boundary.

(3) The instruction stored in the sub-block is an instruction boundary of the 32-bit instruction, while the second pre-decoding information of the sub-block is a non-instruction boundary.

For example, in FIG. 4C, when the instruction is fetched for the second time, the instruction stored in the sub-block 405 is the instruction boundary and low 2 bits of the sub-block 405 are 11, while the second pre-decoding information of the sub-block is the non-instruction boundary.

In the implementation, when it is determined that the second pre-decoding information of the first sub-block is erroneous, the second pre-decoding information of at least one target sub-block (including at least the first sub-block) may be repaired by the method provided in the embodiment of the disclosure. In some implementations, the state machine shown in FIG. 2B may be used to repair the pre-decoding information.

FIG. 4D is a flowchart of an implementation of a method for data processing provided in an embodiment of the disclosure. As shown in FIG. 4D, the method includes the following operations S411 to S422.

In operation S411, a first sub-block is determined from an instruction block stored in an ICache based on a received instruction address.

In operation S412, it is determined whether the first sub-block is a first one of the sub-blocks in the instruction block. If yes, the method proceeds to operation S413; otherwise, the method proceeds to operation S414.

In operation S413, first pre-decoding information of the first sub-block is determined based on instruction information stored in a last one of the sub-blocks of a previous instruction block.

In operation S414, first information is taken as the first pre-decoding information of the first sub-block.

In operation S415, second pre-decoding information of the first sub-block is acquired from the ICache.

In operation S416, it is determined whether the first pre-decoding information of the first sub-block is the same as the second pre-decoding information of the first sub-block. If yes, the method proceeds to operation S422; otherwise, the method proceeds to operation S417.

In operation S417, the second pre-decoding information of the first sub-block is updated to the first pre-decoding information of the first sub-block.

In operation S418, it is determined whether the first sub-block is a last one of the sub-blocks of the instruction block. If yes, the method proceeds to operation S421; otherwise, the method proceeds to operation S419.

In operation S419, for each of at least one second sub-block, first pre-decoding information of the second sub-block is determined based on instruction information stored in a previous sub-block of the second sub-block. Second pre-decoding information of the second sub-block is read from the ICache. The second pre-decoding information of the second sub-block is updated to the first pre-decoding information of the second sub-block when the second pre-decoding information of the second sub-block is different from the first pre-decoding information of the second sub-block. The second pre-decoding information of the second sub-block is kept unchanged when the second pre-decoding information of the second sub-block is the same as the first pre-decoding information of the second sub-block.

In operation S420, the second pre-decoding information of the first sub-block and the respective second pre-decoding information of each second sub-block are written back into the ICache, and the method proceeds to operation S422.

In operation S421, the second pre-decoding information of the first sub-block is written back into the ICache.

In operation S422, the fetched instruction and the second pre-decoding information of the first sub-block are returned to a next stage.

In the embodiment of the disclosure, on one hand, the pre-decoding information of the sub-blocks is determined by the pre-decoding circuit in real time, and the sub-blocks and the pre-decoding information of the sub-blocks are refilled into the ICache, so that the pre-decoding can be performed in advance in the refilling of the ICache, which shares the timing pressure of splitting the instruction boundary, thereby alleviating timing pressures at other stages (such as the instruction prediction stage and the instruction decoding stage), further enabling the processor to better support efficient execution of an instruction pipeline and improving performance of the processor. On the other hand, when the instruction is fetched from the ICache, the second pre-decoding information of the sub-block in the ICache is timely repaired by the pre-decoding repair circuit to obtain an accurate instruction boundary. Since the error of the pre-decoding is allowed, the requirements of the accuracy of the pre-decoding are reduced. Furthermore, since the erroneous pre-decoding can be repaired automatically, there is no need to pre-decode the instruction again, so that the consumption of the access to the memory can be reduced while shortening instruction-fetching time, and a compiler may be allowed not to perform the filling of an NOP instruction in an invalid part of a cache line, thereby reducing the dependency of the CPU on the compiler.

In some implementations, the pre-decoding circuit is further configured to: take first information as second pre-decoding information of a first one of the sub-blocks; and for each of third sub-blocks in the instruction block, determine second pre-decoding information of the third sub-block based on instruction information stored in a previous sub-block of the third sub-block, here each of the third sub-blocks is not the first one of the sub-blocks.

In some implementations, the pre-decoding circuit is further configured to perform at least one of: taking second information as first pre-decoding information of the third sub-block when the instruction information is configured to indicate that low-order bits of the instruction are stored in the previous sub-block; or taking first information as the first pre-decoding information of the third sub-block when the instruction information is configured to indicate that high-order bits of the instruction or all bits of the instruction are stored in the previous sub-block.

In some implementations, the pre-decoding check circuit is further configured to perform at least one of: determining the first pre-decoding information of the first sub-block based on a previous instruction block when the position information is configured to indicate that the first sub-block is a first one of the sub-blocks in the instruction block; or taking first information as the first pre-decoding information of the first sub-block when the position information is configured to indicate that the first sub-block is not the first one of the sub-blocks in the instruction block. The first information is configured to indicate that the instruction stored in the first sub-block is the instruction boundary.

In some implementations, the pre-decoding circuit is further configured to: acquire instruction information stored in a last one of the sub-blocks of the previous instruction block; take second information as the first pre-decoding information of the first sub-block when the instruction information is configured to indicate that low-order bits of the instruction are stored in the last one of the sub-blocks, here the second information is configured to indicate that the instruction stored in the first sub-block is a non-instruction boundary; and take the first information as the first pre-decoding information of the first sub-block when the instruction information is configured to indicate that high-order bits of the instruction or all bits of the instruction are stored in the last one sub-block.

In some implementations, the at least one target sub-block includes the first sub-block. The pre-decoding repair circuit is further configured to: repair the second pre-decoding information of the first sub-block based on the first pre-decoding information of the first sub-block; and when the at least one target sub-block includes at least one second sub-block, for each second sub-block, determine first pre-decoding information of the second sub-block based on instruction information stored in a previous sub-block of the second sub-block, and repair second pre-decoding information of the second sub-block based on the first pre-decoding information of the second sub-block.

In some implementations, the pre-decoding repair circuit is further configured to update the second pre-decoding information of the first sub-block to be the first pre-decoding information of the first sub-block.

In some implementations, the pre-decoding repair circuit is further configured to perform at least one of: taking second information as the first pre-decoding information of the second sub-block when the instruction information is configured to indicate that low-order bits of the instruction are stored in the previous sub-block; or taking first information as the first pre-decoding information of the second sub-block when the instruction information is configured to indicate that high-order bits of the instruction or all bits of the instruction are stored in the previous sub-block.

In some implementations, the pre-decoding repair circuit is further configured to: read the second pre-decoding information of the second sub-block from the ICache; update the second pre-decoding information of the second sub-block to be the first pre-decoding information of the second sub-block when the second pre-decoding information of the second sub-block is different from the first pre-decoding information of the second sub-block; and keep the second pre-decoding information of the second sub-block unchanged when the second pre-decoding information of the second sub-block is the same as the first pre-decoding information of the second sub-block.

The above descriptions of the device embodiments are similar to the above descriptions of the method embodiments, and have beneficial effects similar to those of the method embodiments. Technical details not described in the device embodiments of the disclosure may be understood by referring to the descriptions of the method embodiments of the disclosure.

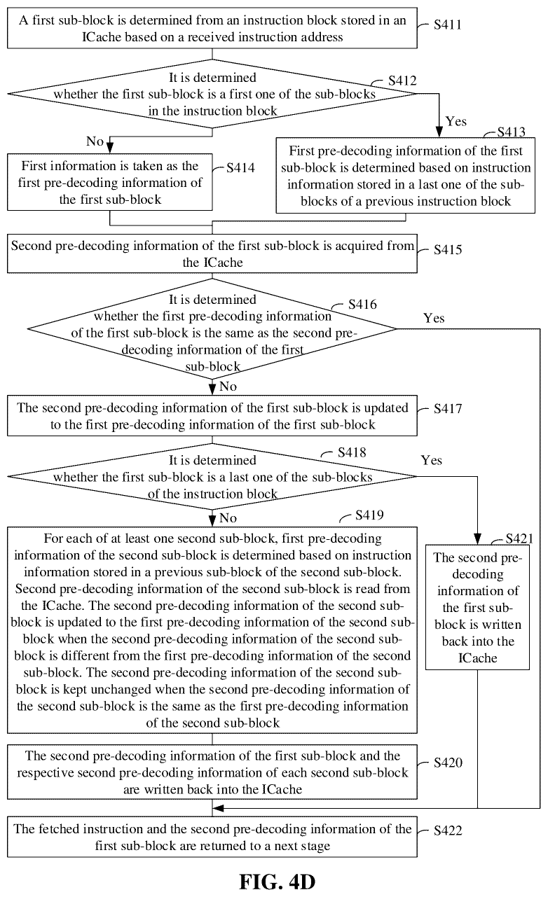

Based on the above embodiments, an embodiment of the disclosure provides an apparatus for data processing. FIG. 5 is a diagram of a compositional structure of an apparatus for data processing provided in an embodiment of the disclosure. As shown in FIG. 5, the apparatus for data processing 50 includes a first determination module 51, a second determination module 52, and a repair module 53.

The first determination module 51 is configured to determine a first sub-block from multiple sub-blocks of an instruction block stored in an ICache based on a fetch instruction.

The second determination module 52 is configured to determine first pre-decoding information of the first sub-block based on position information of the first sub-block in the instruction block. The first pre-decoding information of the first sub-block is configured to indicate whether an instruction stored in the first sub-block is an instruction boundary.

The repair module 53 is configured to repair second pre-decoding information of at least one target sub-block in the instruction block based on the first pre-decoding information of the first sub-block when second pre-decoding information of the first sub-block stored in the ICache is different from the first pre-decoding information of the first sub-block.

In some implementations, the second determination module 52 is further configured to perform at least one of: determining the first pre-decoding information of the first sub-block based on a previous instruction block when the position information is configured to indicate that the first sub-block is a first one of the sub-blocks in the instruction block; or taking first information as the first pre-decoding information of the first sub-block when the position information is configured to indicate that the first sub-block is not the first one of the sub-blocks in the instruction block. The first information is configured to indicate that the instruction stored in the first sub-block is the instruction boundary.

In some implementations, the second determination module 52 is further configured to: acquire instruction information stored in a last one of the sub-blocks of the previous instruction block; take second information as the first pre-decoding information of the first sub-block when the instruction information is configured to indicate that low-order bits of the instruction are stored in the last one sub-block, here the second information is configured to indicate that the instruction stored in the first sub-block is a non-instruction boundary; and take the first information as the first pre-decoding information of the first sub-block when the instruction information is configured to indicate that high-order bits of the instruction or all bits of the instruction are stored in the last one of the sub-blocks.

In some implementations, the at least one target sub-block includes the first sub-block. The repair module 53 is further configured to: repair the second pre-decoding information of the first sub-block based on the first pre-decoding information of the first sub-block; when the at least one target sub-block includes at least one second sub-block, for each second sub-block, determine first pre-decoding information of the second sub-block based on instruction information stored in a previous sub-block of the second sub-block, and repair second pre-decoding information of the second sub-block based on the first pre-decoding information of the second sub-block; and write the repaired second pre-decoding information of the at least one target sub-block back into the ICache.

In some implementations, the repair module 53 is further configured to update the second pre-decoding information of the first sub-block to be the first pre-decoding information of the first sub-block.

In some implementations, the repair module 53 is further configured to perform at least one of: taking second information as the first pre-decoding information of the second sub-block when the instruction information is configured to indicate that low-order bits of the instruction are stored in the previous sub-block; or taking first information as the first pre-decoding information of the second sub-block when the instruction information is configured to indicate that high-order bits of the instruction or all bits of the instruction are stored in the previous sub-block.

In some implementations, the repair module 53 is further configured to: read the second pre-decoding information of the second sub-block from the ICache; update the second pre-decoding information of the second sub-block to be the first pre-decoding information of the second sub-block when the second pre-decoding information of the second sub-block is different from the first pre-decoding information of the second sub-block; and keep the second pre-decoding information of the second sub-block unchanged when the second pre-decoding information of the second sub-block is the same as the first pre-decoding information of the second sub-block.

In some implementations, the apparatus further includes a third determination module, and the third determination module is configured to: acquire the instruction block from a memory; and determine respective second pre-decoding information of each sub-block of the sub-blocks, and store each sub-block of the sub-blocks and the respective second pre-decoding information of the sub-block into the ICache.

In some implementations, the third determination module is further configured to: take first information as second pre-decoding information of the first one of the sub-blocks; and for each of third sub-blocks in the instruction block, determine second pre-decoding information of the third sub-block based on instruction information stored in a previous sub-block of the third sub-block. Each of the third sub-blocks is not the first one of the sub-blocks.

In some implementations, the third determination module is further configured to perform at least one of: taking second information as first pre-decoding information of the third sub-block when the instruction information is configured to indicate that low-order bits of the instruction are stored in the previous sub-block; or taking first information as the first pre-decoding information of the third sub-block when the instruction information is configured to indicate that high-order bits of the instruction or all bits of the instruction are stored in the previous sub-block.

The above descriptions of the apparatus embodiment are similar to the above descriptions of the method embodiments, and have beneficial effects similar to those of the method embodiments. Technical details not described in the apparatus embodiment of the disclosure may be understood by referring to the descriptions of the method embodiments of the disclosure.

It should be noted that in the embodiments of the disclosure, if the above methods are implemented in form of software functional module and sold or used as an independent product, the above methods may also be stored in a computer-readable storage medium. Based on such an understanding, the technical solutions of the embodiments of the disclosure substantially or parts making contributions to some implementations may be embodied in form of software product. The software product may be stored in a storage medium and may include several instructions to enable an electronic device (which may be a personal computer, a server, a network device, etc.) to execute all or part of the methods described in various embodiments of the disclosure. The foregoing storage medium includes various media capable of storing program codes such as a U disk, a mobile hard disk, a Read Only Memory (ROM), a magnetic disk, or an optical disk, etc. In this way, the embodiments of the disclosure are not limited to any particular combination of hardware and software.

An embodiment of the disclosure provides an electronic device, and the electronic device includes a processor and a memory. The memory stores a computer program executable on the processor, any one of the above methods is implemented when the processor executes the computer program.

An embodiment of the disclosure provides a computer-readable storage medium, and the computer-readable storage medium has stored thereon a computer program. Any one of the above methods is implemented when the computer program is executed by a processor. The computer-readable storage medium may be transitory or non-transitory.

An embodiment of the disclosure provides a computer program product, and the computer program product includes a computer program or instruction. Any one of the above methods is implemented when the computer program or instruction is executed by a processor. The computer program product may be specifically implemented by way of hardware, software, or a combination thereof. In an optional embodiment, the computer program product is specifically embodied as a computer storage medium. In another optional embodiment, the computer program product is specifically embodied as a software product, such as a Software Development Kit (SDK), etc.

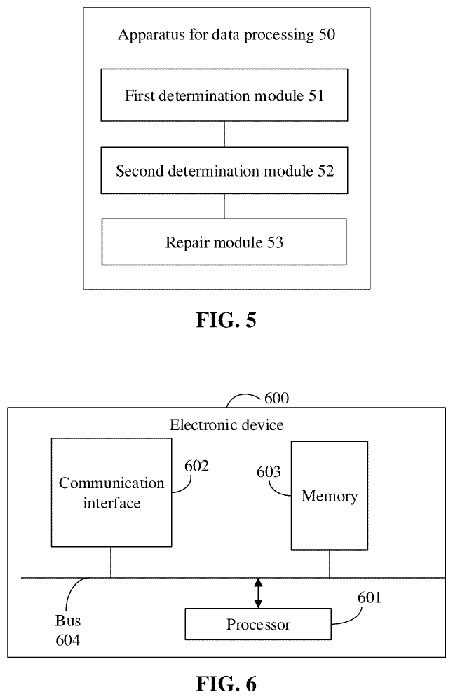

It should be noted that FIG. 6 is a diagram of hardware entities of an electronic device provided in an embodiment of the disclosure. As shown in FIG. 6, the hardware entities of the electronic device 600 include a processor 601, a communication interface 602 and a memory 603.

The processor 601 usually controls overall operations of the electronic device 600.

The communication interface 602 may enable the electronic device to communicate with other terminals or servers through a network.

The memory 603 is configured to store instructions and applications executable by the processor 601, and may also cache data (such as image data, audio data, voice communication data, and video communication data) to be processed or already processed by the processor 601 and various modules in the electronic device 600. The memory 603 may be implemented by a flash memory (FLASH) or a Random Access Memory (RAM). Data transmission among the processor 601, the communication interface 602 and the memory 603 may be performed through a bus 604.

Here, it should be pointed out that the above descriptions of the storage medium and device embodiments are similar to the above descriptions of the method embodiments, and have beneficial effects similar to those of the method embodiments. Technical details not disclosed in the storage medium and device embodiments of the disclosure may be understood by referring to the descriptions of the method embodiments of the disclosure.

It should be understood that “one embodiment” or “an embodiment” mentioned throughout the description mean that specific features, structures or characteristics related to the embodiment are included in at least one embodiment of the disclosure. Therefore, “in one embodiment” or “in an embodiment” present throughout the description does not necessarily refer to the same embodiment. Furthermore, these specific features, structures or characteristics may be combined in one or more embodiments by any suitable manner. It should be understood that in various embodiments of the disclosure, sizes of serial numbers of the above processes do not mean a sequence of execution, and the sequence of execution of each process should be determined by its function and internal logic, and should not constitute any limitation on implementation processes of the embodiments of the disclosure. The above serial numbers of the embodiments of the disclosure are only for the purpose of descriptions, and do not represent advantages and disadvantages of the embodiments.

It should be noted that terms “including”, “include” or any other variants thereof in the context are intended to encompass a non-exclusive inclusion, so that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

In several embodiments provided in the disclosure, it should be understood that the provided devices and methods may be implemented in other manners. The device embodiments as described above are only schematic. For example, the division of the units is only a logic function division, and there may be other division manners in actual implementations. For example, multiple units or components may be combined or integrated into another system, or some features may be neglected or may not be executed. Furthermore, coupling or direct coupling or communication connection between the displayed or discussed components may be indirect coupling or communication connection implemented through some interfaces, of the device or the units, and may be electrical, mechanical or may adopt other forms.

The above units described as separate parts may be or may not be physically separated, and parts displayed as units may be or may not be physical units. That is, they may be located in a place, or may be distributed to multiple network units. Part or all of the units may be selected to achieve the purpose of the solutions in the embodiments according to actual requirements.

Furthermore, various functional units in the embodiments of the disclosure may be integrated into a processing unit, or each unit may be separately used as a unit, or two or more than two units may be integrated into a unit. The above integrated unit may be implemented in form of hardware such as sub-circuit, microprocessor, sub-processor or in form of hardware such as sub-circuit, microprocessor, sub-processor plus software functional units.

It may be understood by those of ordinary skill in the art that all or part of operations implementing the above method embodiments may be completed by hardware related to program instructions, and the foregoing program may be stored in a computer-readable storage medium, and operations including the above method embodiments are executed when the program is executed. The foregoing storage medium includes various media capable of storing program codes such as a mobile storage device, a ROM, a magnetic disk, or an optical disk, etc.

Alternatively, if the above integrated unit of the disclosure is implemented in form of software functional module and sold or used as an independent product, the above integrated unit may also be stored in a computer-readable storage medium. Based on such an understanding, the technical solutions of the disclosure substantially or parts making contributions to some implementations may be embodied in form of software product, and the computer software product is stored in a storage medium, including several instructions to enable an electronic device (which may be a personal computer, a server, a network device, etc.) to execute all or part of the methods described in various embodiments of the disclosure. The foregoing storage medium includes various media capable of storing program codes such as a mobile storage device, a ROM, a magnetic disk, or an optical disk, etc.

The above descriptions are only implementations of the present disclosure. However, the scope of protection of the present disclosure is not limited thereto. Variation or replacement easily conceived by those skilled in the art within the technical scope disclosed in the present disclosure should fall within the scope of protection of the disclosure.

1. A device for data processing, comprising an Instruction Cache (ICache), a pre-decoding circuit, a pre-decoding check circuit, and a pre-decoding repair circuit,
wherein the pre-decoding circuit is configured to: determine a first sub-block from a plurality of sub-blocks of an instruction block stored in the ICache based on a fetch instruction; and determine first pre-decoding information of the first sub-block based on position information of the first sub-block in the instruction block, wherein the first pre-decoding information of the first sub-block is configured to indicate whether an instruction stored in the first sub-block is an instruction boundary,
the pre-decoding check circuit is configured to: acquire second pre-decoding information of the first sub-block from the ICache; determine a check result corresponding to the first sub-block based on the first pre-decoding information of the first sub-block and the second pre-decoding information of the first sub-block; and when the check result corresponding to the first sub-block is a first check result, transmit the first check result to the pre-decoding repair circuit, wherein the first check result is configured to indicate that the first pre-decoding information of the first sub-block is different from the second pre-decoding information of the first sub-block, and
the pre-decoding repair circuit is configured to: repair second pre-decoding information of at least one target sub-block in the instruction block based on the first pre-decoding information of the first sub-block; and write the repaired second pre-decoding information of the at least one target sub-block back into the ICache.

2. The device of claim 1, wherein the pre-decoding check circuit is further configured to store the instruction stored in the first sub-block into a preset instruction queue when the check result corresponding to the first sub-block is a second check result.

3. The device of claim 1, wherein the pre-decoding check circuit is further configured to perform at least one of:
determining the first pre-decoding information of the first sub-block based on a previous instruction block when the position information is configured to indicate that the first sub-block is a first one of the plurality of sub-blocks of the instruction block; or
taking first information as the first pre-decoding information of the first sub-block when the position information is configured to indicate that the first sub-block is not the first one of the plurality of sub-blocks of the instruction block, wherein the first information is configured to indicate that the instruction stored in the first sub-block is the instruction boundary.

4. The device of claim 3, wherein the pre-decoding circuit is further configured to: acquire instruction information stored in a last one of sub-blocks of the previous instruction block; take second information as the first pre-decoding information of the first sub-block when the instruction information is configured to indicate that low-order bits of an instruction are stored in the last one of the sub-blocks, wherein the second information is configured to indicate that the instruction stored in the first sub-block is a non-instruction boundary; and take the first information as the first pre-decoding information of the first sub-block when the instruction information is configured to indicate that high-order bits of the instruction or all bits of the instruction are stored in the last one of the sub-blocks.

5. The device of claim 1, wherein the at least one target sub-block comprises the first sub-block,
the pre-decoding repair circuit is further configured to: repair the second pre-decoding information of the first sub-block based on the first pre-decoding information of the first sub-block; and when the at least one target sub-block comprises at least one second sub-block, for each second sub-block, determine first pre-decoding information of the second sub-block based on instruction information stored in a previous sub-block of the second sub-block, and repair second pre-decoding information of the second sub-block based on the first pre-decoding information of the second sub-block.

6. The device of claim 5, wherein the pre-decoding repair circuit is further configured to update the second pre-decoding information of the first sub-block to be the first pre-decoding information of the first sub-block.

7. The device of claim 5, wherein the pre-decoding repair circuit is further configured to perform at least one of:
taking second information as the first pre-decoding information of the second sub-block when the instruction information is configured to indicate that low-order bits of an instruction are stored in the previous sub-block; or
taking first information as the first pre-decoding information of the second sub-block when the instruction information is configured to indicate that high-order bits of the instruction or all bits of the instruction are stored in the previous sub-block.

8. The device of claim 5, wherein the pre-decoding repair circuit is further configured to: read the second pre-decoding information of the second sub-block from the ICache; update the second pre-decoding information of the second sub-block to be the first pre-decoding information of the second sub-block when the second pre-decoding information of the second sub-block is different from the first pre-decoding information of the second sub-block; and
keep the second pre-decoding information of the second sub-block unchanged when the second pre-decoding information of the second sub-block is the same as the first pre-decoding information of the second sub-block.

9. The device of claim 1, wherein the pre-decoding circuit is further configured to: acquire the instruction block from a memory; and determine respective second pre-decoding information of each sub-block of the plurality of sub-blocks, and store each sub-block of the plurality of sub-blocks and the respective second pre-decoding information of the sub-block into the ICache.

10. The device of claim 9, wherein the pre-decoding circuit is further configured to: take first information as second pre-decoding information of a first one of the plurality of sub-blocks;
and for each of third sub-blocks of the instruction block, determine second pre-decoding information of the third sub-block based on instruction information stored in a previous sub-block of the third sub-block, wherein each of the third sub-blocks is not the first one of the plurality of sub-blocks.

11. The device of claim 10, wherein the pre-decoding circuit is further configured to perform at least one of:
taking second information as first pre-decoding information of the third sub-block when the instruction information is configured to indicate that low-order bits of an instruction are stored in the previous sub-block; or
taking first information as the first pre-decoding information of the third sub-block when the instruction information is configured to indicate that high-order bits of the instruction or all bits of the instruction are stored in the previous sub-block.

12. A method for data processing, comprising:
determining a first sub-block from a plurality of sub-blocks of an instruction block stored in an Instruction Cache (ICache) based on a fetch instruction;
determining first pre-decoding information of the first sub-block based on position information of the first sub-block in the instruction block, wherein the first pre-decoding information of the first sub-block is configured to indicate whether an instruction stored in the first sub-block is an instruction boundary; and
repairing second pre-decoding information of at least one target sub-block in the instruction block based on the first pre-decoding information of the first sub-block when second pre-decoding information of the first sub-block stored in the ICache is different from the first pre-decoding information of the first sub-block.

13. The method of claim 12, wherein determining the first pre-decoding information of the first sub-block based on position information of the first sub-block in the instruction block comprises at least one of:
determining the first pre-decoding information of the first sub-block based on a previous instruction block when the position information is configured to indicate that the first sub-block is a first one of the plurality of sub-blocks of the instruction block; or
taking first information as the first pre-decoding information of the first sub-block when the position information is configured to indicate that the first sub-block is not the first one of the plurality of sub-blocks of the instruction block, wherein the first information is configured to indicate that the instruction stored in the first sub-block is the instruction boundary.

14. The method of claim 13, wherein determining the first pre-decoding information of the first sub-block based on the previous instruction block comprises:
acquiring instruction information stored in a last one of sub-blocks of the previous instruction block;
taking second information as the first pre-decoding information of the first sub-block when the instruction information is configured to indicate that low-order bits of an instruction are stored in the last one of the sub-blocks, wherein the second information is configured to indicate that the instruction stored in the first sub-block is a non-instruction boundary; and
taking the first information as the first pre-decoding information of the first sub-block when the instruction information is configured to indicate that high-order bits of the instruction or all bits of the instruction are stored in the last one of the sub-blocks.

15. The method of claim 12, wherein the at least one target sub-block comprises the first sub-block,
wherein repairing the second pre-decoding information of the at least one target sub-block in the instruction block based on the first pre-decoding information of the first sub-block comprises:
repairing the second pre-decoding information of the first sub-block based on the first pre-decoding information of the first sub-block;
when the at least one target sub-block comprises at least one second sub-block, for each second sub-block, determining first pre-decoding information of the second sub-block based on instruction information stored in a previous sub-block of the second sub-block, and repairing second pre-decoding information of the second sub-block based on the first pre-decoding information of the second sub-block; and
writing repaired second pre-decoding information of the at least one target sub-block back into the ICache.

16. The method of claim 15, wherein repairing the second pre-decoding information of the first sub-block based on the first pre-decoding information of the first sub-block comprises:
updating the second pre-decoding information of the first sub-block to be the first pre-decoding information of the first sub-block.

17. The method of claim 15, wherein determining the first pre-decoding information of the second sub-block based on the instruction information stored in the previous sub-block of the second sub-block comprises at least one of:
taking second information as the first pre-decoding information of the second sub-block when the instruction information is configured to indicate that low-order bits of an instruction are stored in the previous sub-block; or
taking first information as the first pre-decoding information of the second sub-block when the instruction information is configured to indicate that high-order bits of the instruction or all bits of the instruction are stored in the previous sub-block.

18. The method of claim 15, wherein repairing the second pre-decoding information of the second sub-block based on the first pre-decoding information of the second sub-block comprises:
reading the second pre-decoding information of the second sub-block from the ICache;
updating the second pre-decoding information of the second sub-block to be the first pre-decoding information of the second sub-block when the second pre-decoding information of the second sub-block is different from the first pre-decoding information of the second sub-block; and
keeping the second pre-decoding information of the second sub-block unchanged when the second pre-decoding information of the second sub-block is the same as the first pre-decoding information of the second sub-block.

19. The method of claim 12, further comprising:
acquiring the instruction block from a memory;
determining respective second pre-decoding information of each sub-block of the plurality of sub-blocks; and
storing each sub-block of the plurality of sub-blocks and the respective second pre-decoding information of the sub-block into the ICache.

20. A computer-readable storage medium having stored thereon a computer program that, when executed by a processor, implements:
determining a first sub-block from a plurality of sub-blocks of an instruction block stored in an Instruction Cache (ICache) based on a fetch instruction;
determining first pre-decoding information of the first sub-block based on position information of the first sub-block in the instruction block, wherein the first pre-decoding information of the first sub-block is configured to indicate whether an instruction stored in the first sub-block is an instruction boundary; and
repairing second pre-decoding information of at least one target sub-block in the instruction block based on the first pre-decoding information of the first sub-block when second pre-decoding information of the first sub-block stored in the ICache is different from the first pre-decoding information of the first sub-block.
